(19) United States
(12) Patent Application Publication
(10) Pub. No.: US 2009/0109022 A1
(43) Pub. Date: Apr. 30, 2009

(54) Method and apparatus for providing in-vehicle fuel related information

(75) Inventors: Anupam Gangopadhyay, Troy, MI (US); Man-Feng Chang, Troy, MI (US); Chen-Fang Chang, Troy, MI (US); Oguz H. Dagci, Sterling Heights, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/931,360

(22) Filed: Oct. 31, 2007

(51) Int. Cl. G08B 21/00

(52) U.S. Cl. 340/540; 701/123

(57) ABSTRACT

A method for providing in-vehicle fuel-related information is disclosed. A geographic location of a vehicle is determined. A driving distance remaining for the vehicle is estimated based on a current fuel level and a fuel consumption rate of the vehicle. Fuel providers are located within a search area of the driving distance remaining for the vehicle, and one or more of the fuel providers are output. A travel cost for the vehicle may also be calculated.

### BACKGROUND OF THE INVENTION

The present disclosure relates generally to a method and apparatus for providing in-vehicle fuel-related information.

Some vehicles are equipped with value added features that determine the location of a vehicle, calculate the average or instantaneous fuel consumption rate as distance-per-unit-of-measure (e.g., miles-per-gallon of gasoline) over a period of time, or calculate the estimated travel distance remaining based upon the vehicle fuel consumption rate and the amount of fuel remaining in the vehicle. Other systems have been considered that provide a user of a vehicle with information regarding the location of a nearby gas station and the price of the gasoline at that station. Yet other systems have been considered that provide a user of a vehicle with information regarding the location of the nearest gas station that carries the driver's preferred gasoline manufacturer. Further, other systems have been considered that provide a user of a vehicle with information regarding the location of the nearest gas station that carries the driver's preferred grade of gasoline. However, these systems do not supply complete information relative to the vehicle location, about the lowest cost fuel provider that provides the type of fuel that the vehicle consumes, particularly when the vehicle is capable of consuming multiple types of fuel or alternative fuels. Nor do these systems provide complete information about the actual cost of a trip. Furthermore, these systems do not consider the amount of fuel remaining in the vehicle in limiting the search area for fuel providers.

Accordingly, there is a need in the art for a method and apparatus for providing in-vehicle fuel-related information that overcomes these drawbacks.

### BRIEF DESCRIPTION OF THE INVENTION

An embodiment of the invention includes a method for providing in-vehicle fuel-related information. A geographic location of a vehicle is determined. A driving distance remaining for the vehicle is estimated based on a current fuel level and a fuel consumption rate of the vehicle. Fuel providers are located within a search area of the driving distance remaining for the vehicle, and one or more of the fuel providers are output.

Another embodiment of the invention includes an apparatus for providing in-vehicle fuel-related information. A processing circuit responsive to executable instructions which, when executed by the processing circuit: determines a geographic location of a vehicle; estimates a driving distance remaining for the vehicle based on a current fuel level and a fuel consumption rate of the vehicle; locates fuel providers within a search area of the driving distance remaining for the vehicle; and outputs one or more of the fuel providers.

A further embodiment of the invention includes a method for providing in-vehicle fuel related information. A travel cost calculation is initiated, and an initial amount of fuel available in a vehicle prior to an additional amount of fuel being added is determined. The cost of the initial amount of fuel is determined through receiving information about the cost-per-unit-of-measure of the initial amount of fuel, and multiplying this cost-per-unit-of-measure by the initial amount. An additional amount of fuel being added to the vehicle is sensed, and the amount of fuel added is determined. The total amount of fuel available from the initial amount and the amount added is also determined. The cost of the additional amount of fuel is determined through receiving from a provider of the additional amount of fuel the provider's cost-per-unit-of-measure, and multiplying the provider's cost-per-unit-of-measure by the additional amount. The average monetary value of the total amount of fuel is determined by adding the cost of the initial amount of fuel to the cost of the additional amount of fuel to determine a total cost of the total amount of fuel, and dividing the total cost by the total amount of fuel to determine the average-cost-per-unit-of-measure of the total amount of fuel available. A user of the vehicle is provided the average monetary value of the total amount of fuel available, including: providing to a user of the vehicle the average-cost-per-unit-of-measure of the total amount of fuel available, the total cost of the total amount of fuel available, or both. The travel cost calculation is concluded, and in response thereto, the amount of fuel consumed since the initiating step is determined, and the cost of the fuel consumed is calculated by multiplying the amount of fuel consumed by the average monetary value of the total amount of fuel available, the average monetary value being provided as a per-unit-of-measure value.

Other methods and/or apparatuses according to embodiments will be or become apparent to one with skill in the art upon review of the following drawings and detailed description. It is intended that all such additional methods and/or apparatuses be included within this description, be within the scope of the present invention, and be protected by the accompanying claims.

### BRIEF DESCRIPTION OF THE DRAWINGS

Referring to the exemplary drawings wherein like elements are numbered alike in the accompanying Figures:

FIG. 1 depicts an exemplary vehicle for practicing exemplary embodiments of the invention;

FIG. 2 depicts an exemplary process flow diagram for practicing exemplary embodiments of the invention;

FIG. 3 depicts search area schemes that may be implemented by exemplary embodiments of the invention;

FIG. 4 depicts another exemplary process flow diagram for practicing exemplary embodiments of the invention; and

FIG. 5 depicts a further exemplary process flow diagram for practicing exemplary embodiments of the invention.

### DETAILED DESCRIPTION OF THE INVENTION

Exemplary embodiments, as shown and described by the various FIGs. and the accompanying text, provide methods, apparatuses and computer useable mediums having computer readable program code, for providing in-vehicle fuel-related information. Exemplary embodiments determine a geographic location of a vehicle and an estimated driving distance remaining for the vehicle (e.g., based on the amount of fuel currently in the fuel tank and a fuel consumption rate of the vehicle). Fuel providers within the estimated driving distance of the vehicle are located. All or a subset of these fuel providers are communicated to the driver of the vehicle based on criteria specified by the driver such as the most inexpensive fuel; the fuel providers located in the same direction that the vehicle is currently heading, and/or the fuel providers with a particular type of fuel (e.g., gasoline and ethanol).

While embodiments described herein portray gasoline as a fuel used in a vehicle, and the value of the fuel being provided in units of dollars-per-gallon, it will be appreciated that the disclosed invention is not so limited, and that the scope of the invention also includes other fuels, such as diesel fuel, ethanol fuel, E85 fuel, hydrogen fuel, and electricity, for example, and other units of measure, such as euros-per-liter, and dollars (or any other currency) per kilowatt-hour, for example. The term “fuel filling station” is synonymous with a “fuel provider” and indicates any location capable of providing fuel for a vehicle, such as a gasoline station, vehicle dealership, or other any other provider of fuel.

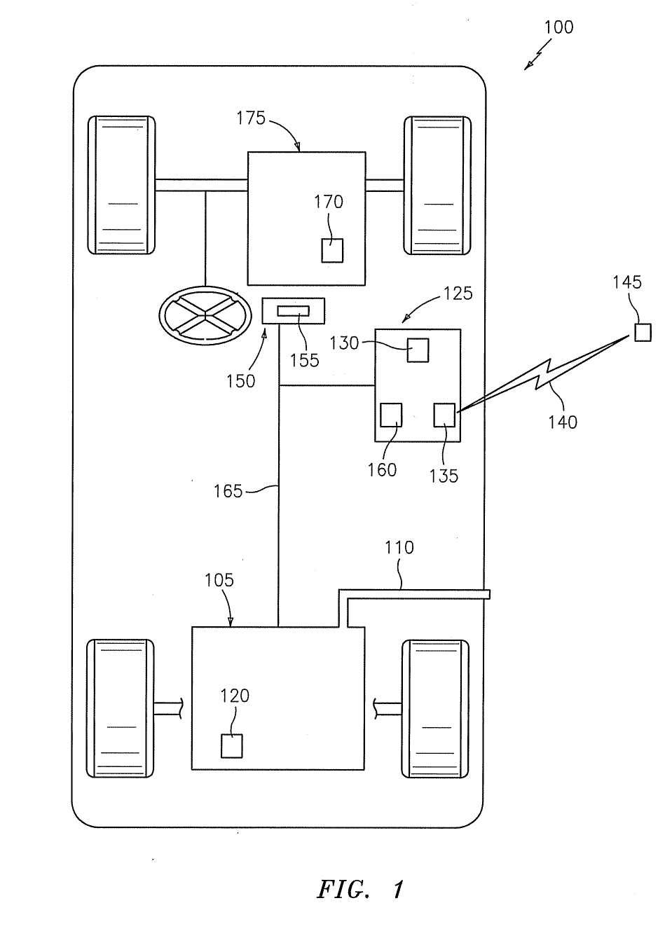

Referring now to FIG. 1, an exemplary embodiment of a vehicle 100 is depicted having a fuel storage tank 105, a fuel filling conduit 110, a sensor 120 for sensing the amount of fuel in the fuel storage tank 105, a dashboard console 150 for receiving commands from a user and for providing information to the user via input/output means 155, an oxygen sensor 170 in an exhaust port of a vehicle engine 175, and a controller 125 for communicating with the various sensors and the dashboard console 150 and for providing in-vehicle fuel related information, which will be discussed in more detail below. The fuel storage tank 105 may hold any type of fuel that can be consumed by the vehicle, such as liquid fuel, gaseous fuel, or solid fuel. In alternate exemplary embodiments, the fuel storage tank 105 may consist of a battery, a collection of batteries, or any apparatus capable of storing an electrical charge. It will be understood by those skilled in the art that vehicle engine 175 may be a single engine or a combination of engines capable of propelling vehicle 100 into motion.

In exemplary embodiments, the controller 125 includes a processing circuit 130 responsive to executable instructions for performing calculations disclosed herein, and a receiver 135 responsive to signals 140 from a source 145. In exemplary embodiments, the source 145 is a satellite system, a cellular communication system, or any other system capable of communicating fuel cost information to the vehicle 100 via the controller 125. The location of fuel filling stations may be loaded into the controller 125 through programmable media or transmitted from the source 145 to the receiver 135.

In exemplary embodiments, input/output means 155 include a first pushbutton for initiating a fuel information request, and a screen for displaying results. The input/output means 155 may also include a keypad or a touch sensitive screen for inputting alphanumerical information and for navigating through on-screen menu options. In alternate embodiments, the input/output means 155 may accept voice input and/or produce audio output of results. In exemplary embodiments, the controller 125 includes a memory 160 for storing information such as fuel price, fuel type, fuel provider location, route of travel, and fuel stations frequented.

The controller 125, sensor 120, dashboard console 150, and the connecting signal lines 165, are collectively referred to as an apparatus for providing in-vehicle fuel related information.

In exemplary embodiments, a user initializes the in-vehicle fuel related information apparatus by requesting fuel filling station information through the input/output means 155. In other embodiments, the controller 125 calculates the driving distance remaining based on the current fuel level read through sensor 120 multiplied by a vehicle fuel consumption rate, initializing the apparatus when the calculated driving distance remaining falls below a safety margin distance threshold value. In alternate embodiments, the apparatus initializes when the controller 125 determines through sensor 120 that the fuel level is lower than a fuel level threshold value. Both the safety margin distance threshold value and fuel level threshold value may be programmed by the user or set to a factory default and stored in the memory 160.

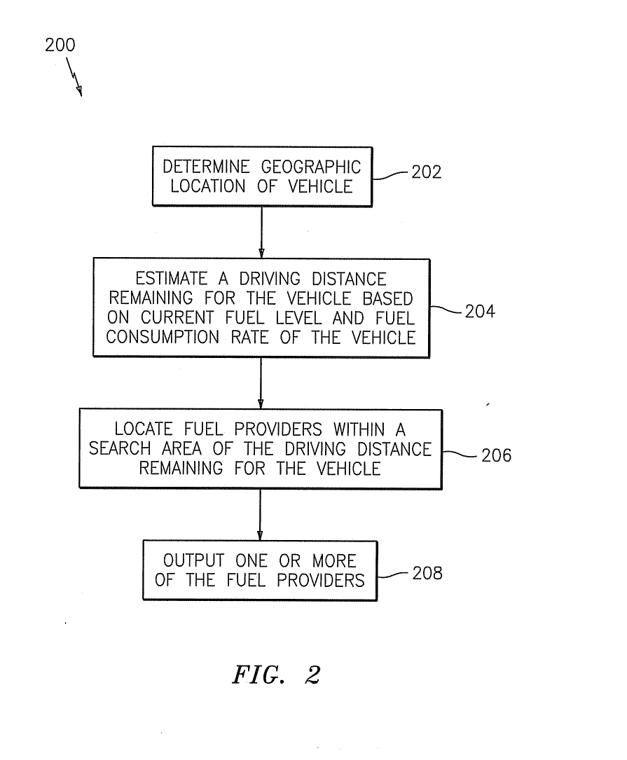

Referring now to FIG. 2, a process flow 200 is depicted for implementing exemplary embodiments. At block 202, the geographic location of the vehicle 100 is determined. In exemplary embodiments, the geographic location of the vehicle 100 is determined through global positioning system (GPS) information as calculated by the controller 125 from information received through the receiver 135. At block 204, the driving distance remaining for the vehicle 100 is estimated based on the current fuel level and fuel consumption rate of the vehicle. The controller 125 may determine the current fuel level via the sensor 120. The controller 125 may also calculate the fuel consumption rate of the vehicle 100 by periodically dividing the distance traveled by the change in fuel level for the vehicle 100 over the period. As previously mentioned, the driving distance remaining for the vehicle 100 may be estimated by multiplying the current fuel level by the fuel consumption rate. The driving distance remaining for the vehicle 100 is considered an estimate because future driving-patterns, such as changing from city to highway driving, may affect the accuracy of the calculation as the fuel consumption rate changes.

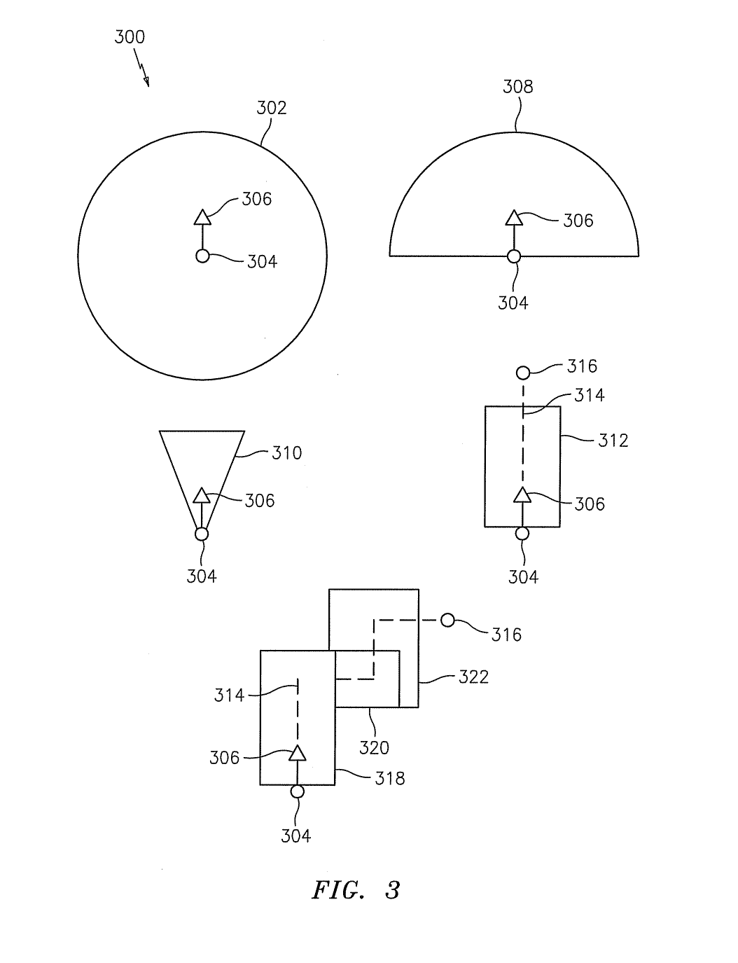

At block 206, the controller 125 locates fuel providers within a search area limited by the driving distance remaining for the vehicle 100. FIG. 3 illustrates a collection of exemplary search area patterns 300, which may be used to further limit the search area. Point 304 represents the current location of the vehicle 100 and arrow 306 represents the direction of travel of the vehicle 100. The search area for fuel providers may be constrained by limiting the search area to a circular region 302 with a radius set equal to the lesser of the driving distance remaining for the vehicle 100 or a search distance threshold. The search distance threshold value may be programmed by the user or set to a factory default and stored in the memory 160. The search distance threshold value may also be responsive to and/or separate from the safety margin distance threshold value. In exemplary embodiments, the circular region 302 may be a circle of a constant radius or any near circular shape, such as an N-sided polygon.

The search area may be further constrained through a user selection via the input/output means 155, allowing the user to select a preference of optimum fuel provider price or optimum time to a fuel provider. In exemplary embodiments, the selection of optimum fuel provider price or optimum time to a fuel provider may be performed by the user in real-time or may be stored in and retrieved from the memory 160. When optimum price is selected, the search area may remain as circular region 302. Furthermore, when optimum price is selected, the direction of travel 306 may not be relevant because a user may be willing to travel in any direction to attain the lowest total cost of fuel.

Continuing with block 206, when optimum time is selected, the controller 125 checks whether a route to a destination 316 is known. When the destination 316 is unknown to the controller 125 and optimum time has been selected, the controller 125 may further limit the search area based upon the direction of travel 306, preferring fuel providers closer to the direction of travel 306 over fuel providers in a direction opposite to the direction of travel 306, using search area patterns such as semi-circle 308 or triangle 310. The direction opposite to the direction of travel 306 may include a geographical region at an angle greater than +/−90 degrees relative to the direction of travel 306. It will be appreciated by those skilled in the art that the semi-circle 308 or triangle 310 may vary in angular degrees covered relative to the direction of travel 306. Furthermore the search area shape, such as semi-circle 308 or triangle 310, may be any arbitrary shape that favors the region angularly closer to the direction of travel 306 as opposed to the region in the direction opposite to the direction of travel 306.

When optimum time is selected and the controller 125 knows the destination 316, the search area is confined to a region closer to a route 314 between the current vehicle location 304 and the destination 316, such as the rectangle 312. When the route 314 contains turns, multiple search areas may be combined such as rectangle areas 318, 320, and 322 to form a search area that accounts for planned changes in vehicle direction. It will be appreciated by those skilled in the art that the shape of search areas may vary based on various factors such as curves in the road or roads along the route 314.

As previously discussed, fuel providers may be located by the controller 125 through accessing the memory 160 if previously stored, through other programmable media, or may be received as a transmission from a source 145 to the receiver 135. The fuel providers located in block 206 may be further filtered based upon the search area and the type of fuel available, such that only fuel providers that carry a fuel type compatible with the vehicle engine 175 and within the search area are considered. Fuel price information, as received by the controller 125 through the receiver 135, may be analyzed to determine the lowest cost options. The list of compatible fuel providers may be ranked based upon the lowest price options within the search area. In exemplary embodiments, if the vehicle engine 175 is only compatible with one type of fuel such as gasoline or only a single type of fuel is available within the search area, then the fuel price comparison is based on cost-per-unit-of-measure, such as dollars-per-gallon.

In exemplary embodiments, if the vehicle engine 175 is compatible with multiple types of fuel available in the search area, such as gasoline, E85, hydrogen, electricity, or other fuel types, the fuel price may be normalized to account for the differences in fuel consumption rate of the vehicle 100 for each fuel type. Price normalization may be calculated as a price-per-unit-of-distance value for each fuel type by multiplying each fuel price-per-unit-of-measure with a respective unit-of-measure-per-unit-of-distance. In exemplary embodiments, fuel price-per-unit-of-measure may be dollars-per-gallon, euros-per-liter, or any other combination such as dollars-per-kilowatt-hour. A fuel type unit-of-measure-per-unit-of-distance may be gallons-per-mile, liters-per-kilometer, or any other combination such as kilowatt-hours-per-kilometer. Fuel type unit-of-measure-per-unit-of-distance values may be determined for each fuel type by accessing records in the memory 160 based on either actual past usage data for the vehicle or from estimated values for the vehicle, such as the vehicle manufacturer or EPA data. By normalizing the price for each potential fuel type available to the user, the in-vehicle fuel-related information system allows the user to select the lowest cost option regardless of the type of fuel consumed by the vehicle.

The controller 125 may also calculate the amount of fuel required to fill the fuel storage tank 105 by subtracting the amount of fuel remaining in the fuel storage tank 105 from the maximum fuel tank capacity. In determining the rank of each potential fuel provider in the search area, the controller 125 may calculate the total potential cost of each fuel provider option as the anticipated cost to fill the fuel storage tank 105 plus the cost to drive to the fuel provider. In exemplary embodiments, when the cost between multiple stations is about the same, the list may be adjusted to rank fuel providers previously visited higher such that the user's apparent preference of particular fuel providers is accommodated. In exemplary embodiments, the list of preferred fuel providers based on fuel manufacturer or particular fuel station may be programmed by the user and committed to the memory 160.

It will be understood by those skilled in the art that the order of processing the blocks in FIG. 2 may be changed, for example, fuel providers may first be located for the search area associated with optimum price and then selectively eliminated as the search area is refined based upon a known travel direction or route to a destination. Alternatively, fuel provider information may be queried to include only the most restrictive search area as determined by the process, eliminating the need for the controller 125 to filter fuel providers from a larger search area.

In block 208, the controller 125 makes the ranked list of fuel providers available to the user through the input/output means 155 and/or the dashboard console 150. In exemplary embodiments, the output of fuel providers may be displayed visually, output as audio, or a combination thereof.

Further exemplary embodiments, as shown and described by the various FIGs. and accompanying text, provide methods for calculating travel cost for a vehicle. A first algorithm is implemented to calculate the average monetary value of the total amount of fuel available in the vehicle based on information about the value of the fuel available prior to additional fuel being added, and about the value of the additional fuel added. A second algorithm is implemented to calculate the cost of the fuel consumed within a window of time, by multiplying the amount of fuel consumed by the average monetary value (a per-unit-of-measure value) of the total amount of fuel available.

As mentioned, exemplary embodiments of the invention for calculating travel cost for a vehicle employ two algorithms. The first algorithm calculates the monetary value of the fuel that is put into the fuel tank of the vehicle. When the driver stops at a fuel filling station and fuels the tank, a controller detects an increase in fuel level via a fuel level sensor, and then gets the provider's pricing information at the gas station equipped with a transmitter for communicating this information to the controller on the vehicle. Since there are different types of gasoline in gas stations that can be used by the vehicle, there are three options to learn the price of the gas that is put into the tank. The first option is to take the average prices of the gas types, with which the vehicle can run. The second option is to take the price of the gas type that is recommended by the vehicle manufacturer. The third option is to take the price of the gasoline that is selected by a selection switch on the fuel dispensing apparatus. If the vehicle is equipped to use both gasoline and alternative fuel, the controller unit can determine what type of fuel is being put into the vehicle by looking at the oxygen content of the exhaust gases from the engine via oxygen sensors and/or other types of sensors, after the vehicle's engine is running again. Since the controller can determine the fuel level before and after adding fuel to the tank, the difference in those readings will provide how many gallons of fuel are added. From all of the information gathered by the controller, the controller can calculate the cost of fuel added. Since the tank would typically not be completely empty at the time of refilling, the average price per gallon of fuel in the tank after refilling needs to be adjusted by taking into account the fuel in the tank prior to refilling. The second algorithm calculates the travel cost from departure point to destination. In response to this second algorithm being activated by the driver, or a passenger, the algorithm polls whether cost calculation is desired or not. If the driver wants to learn the travel cost, the controller looks at how many gallons of fuel has been consumed since the start of the travel cost algorithm. Since the average monetary value of the fuel in the tank is known from the first algorithm, the controller can calculate what the actual travel cost is based on the amount of fuel consumption.

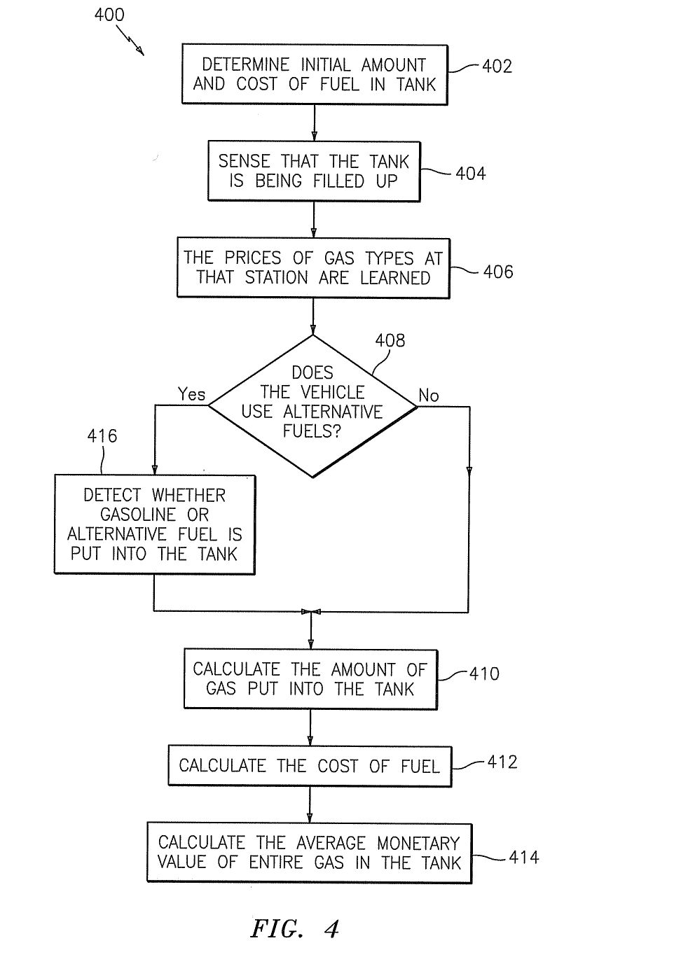

Referring now to FIG. 4, an algorithm 400 is depicted for implementing exemplary embodiments. At block 402, an initial amount of fuel available in the vehicle is determined prior to an additional amount of fuel being added, and the cost of the initial amount of fuel is determined. The operations of block 402 may be accomplished via the aforementioned initialization step, where information about the cost-per-unit-of-measure of the initial amount of fuel is received from memory 160, and this cost-per-unit-of-measure (cost-per-gallon for example) is multiplied by the initial amount of fuel available. At block 404 and in response to the driver stopping to get fuel at a fuel filling station, sensor 120 senses an additional amount of fuel being added to the vehicle. At block 406, receiver 135 receives a transmission from source 145 that provides controller 125 with the provider's cost-per-gallon (or cost-per-unit-of-measure generally) of the fuel being added, also herein referred to as the provider's fuel cost. At block 408, controller 125 determines from vehicle system information whether the vehicle is equipped to use alternative fuels. In response to the determination at block 408 being negative, system logic passes to block 410 where sensor 120 senses the fuel level change in tank 105, and controller 125 determines the amount of fuel added and the total amount of fuel available from the initial amount and the amount added. At block 412, controller 125 calculates the cost of the additional amount of fuel by multiplying the provider's fuel cost-per-unit-of-measure by the volume of fuel added. At block 414, controller 125 calculates the average monetary value of the total amount of fuel, and then provides a user of the vehicle with the average monetary value of the total amount of fuel available, such as the average-cost-per-unit-of-measure of the total amount of fuel available, the total cost of the total amount of fuel available, or both, thereby providing the user with information relating to travel cost. In exemplary embodiments, calculating the average monetary value of the total amount of fuel available (Valueₜₒₜ) is accomplished by adding the cost of the initial amount of fuel (Cost_{fi}) available to the cost of the additional amount of fuel added (Cost_{fa}) to determine a total cost of the total amount of fuel, and then dividing the total cost by the total amount of fuel available (Volumeₜₒₜ) to determine the average-cost-per-unit-of-measure of the total amount of fuel available, which is exemplified in Equation-1.

Valueₜₒₜ($/gal)=[Cost_{fi}($)+Cost_{fa}($)]/[Volumeₜₒₜ(gal)] Equa.-1

where:

Cost_{fi}($)=[initital fuel volume (gal)][initial fuel price ($/gal)]

Cost_{fa}($)=[added fuel volume (gal)][provider's fuel price ($/gal)].

In response to the determination at block 408 being positive, system logic passes to block 416 where controller 125 triggers an oxygen sensor 170 in an exhaust port of engine 175 to sense the oxygen content of exhaust gases once the vehicle engine is running again, then system logic passes to block 410.

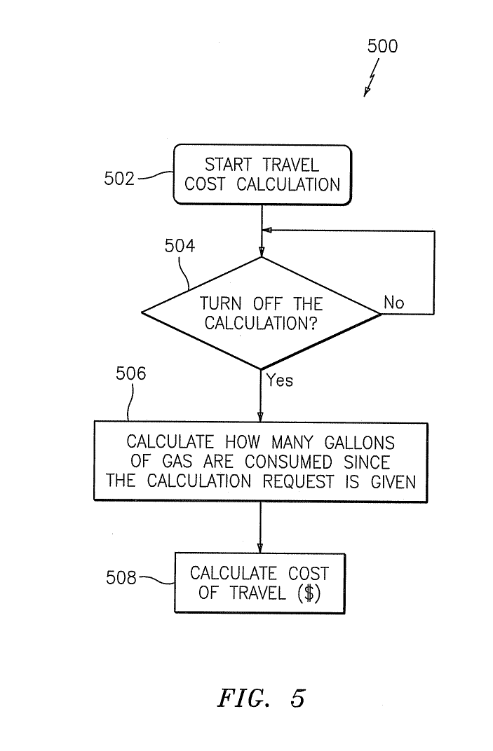

Referring now to FIG. 5, an algorithm 500 is depicted for implementing further exemplary embodiments. At block 502, the driver or user of the travel cost apparatus initiates a travel cost calculation via input/output means 155. In exemplary embodiments, this initiation is accomplished by pressing a pushbutton. At block 504, controller 125 determines whether the user has turned off the calculation function thereby signaling the controller 125 to conclude the travel cost calculation, which in exemplary embodiments may be accomplished by again pressing the initiation pushbutton or pressing another pushbutton. In response to the determination at block 504 being negative, controller 125 continues to proceed with the travel cost calculation. In response to the determination at block 504 being positive, system logic passes to block 506 where controller 125 determines the amount of fuel consumed since the initiating step was activated, and at block 508 calculates the cost of the fuel consumed (TravelCost_{fc}($)) by multiplying the amount of fuel consumed (Volume_{fc}(gal)) by the average monetary value of the total amount of fuel available (Valueₜₒₜ), the average monetary value being provided as a per-unit-of-measure value, which is exemplified in Equation-2.

TravelCost_{fc}($)=[Volume_{fc}(gal)]*[Valueₜₒₜ($/gal)]. Equa.-2

Controller 125 then makes available to the user the cost of the fuel consumed as a total cost of the fuel consumed, a cost-per-unit-of-measure, or both.

Exemplary embodiments of the invention may be embodied in the form of computer-implemented processes and systems for practicing those processes. The present invention may also be embodied in the form of a computer program product having computer program code containing instructions embodied in tangible media, such as floppy diskettes, CD-ROMs, hard drives, universal serial bus (USB) drives, or any other computer readable storage medium, such as read-only memory (ROM), random access memory (RAM), and erasable-programmable read only memory (EPROM), for example, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes a system for practicing the invention. When implemented on a general-purpose microprocessor, the computer program code segments configure the microprocessor to create specific logic circuits. A technical effect of the executable instructions is to generate a ranked list of fuel providers near the vehicle based on the type of fuel consumed, while also accounting for such factors as user preference for time over cost, direction and route of the vehicle, with the list ranked on lowest cost and other user preference information. A further technical effect of the executable instructions is to calculate travel cost relating to fuel consumption and to provide to a user of the vehicle the total average monetary value of the total amount of fuel available in the vehicle, the average-cost-per-unit-of-measure of the total amount of fuel available, and the cost of fuel consumed within a window of time, thereby providing the user with information relating to travel cost.

As disclosed, some embodiments of the invention may include some of the following advantages: a ranked list of fuel providers based on lowest cost, selectable optimization based on cost or travel time, the ability to account for the user preference for particular fuel stations or fuel manufacturers; and, a value added feature that allows a user to learn the cost of routes to fuel providers, and to evaluate which route is the most cost effective based on normalized fuel price when the vehicle accepts alternative fuels.

Furthermore, some embodiments of the invention may include some of the following advantages: a true calculation of the cost of travel that takes into account the amount of fuel consumed and the cost of the fuel consumed, which will include idle time where the vehicle is in stationary traffic; a true calculation of the cost of travel that will take into account high fuel consumption due to a heavy payload; and, a value added feature that allows a driver to learn the cost of alternative routes from one point to another and to evaluate which route is cost effective based on fuel consumption and not just distance alone.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for providing in-vehicle fuel-related information, the method comprising:
determining a geographic location of a vehicle;
estimating a driving distance remaining for the vehicle based on a current fuel level and a fuel consumption rate of the vehicle;
locating fuel providers within a search area of the driving distance remaining for the vehicle; and
outputting one or more of the fuel providers.

2. The method of claim 1, wherein the search area is determined by:
comparing the driving distance remaining for the vehicle with a search distance threshold; and
setting the search area to the lesser of the driving distance remaining for the vehicle and the search distance threshold.

3. The method of claim 1, further comprising receiving a user preference for optimum time, wherein the search area is constrained based upon a direction of travel of the vehicle such that fuel providers closer to the direction of travel are preferred over fuel providers in an opposite direction of travel.

4. The method of claim 1, further comprising receiving a user preference for optimum time and a vehicle destination, wherein the search area is constrained based upon a route of travel to the vehicle destination such that fuel providers closer to the route of travel are preferred over fuel providers further from the route of travel.

5. The method of claim 1, further comprising receiving a fuel price per unit of measure for a fuel type compatible with the vehicle from the fuel providers within the search area and ranking the fuel providers from lowest to highest fuel price per unit of measure.

6. The method of claim 5, wherein the ranking of the fuel providers within the search area is furthered adjusted favoring previously selected fuel providers.

7. The method of claim 5, wherein the ranking of the fuel providers within the search area is further adjusted favoring fuel providers in closer geographic proximity to the vehicle.

8. The method of claim 5, wherein the outputting includes the fuel providers within the search area and their associated rankings.

9. The method of claim 1, further comprising:
receiving a fuel price per unit of measure for one fuel type compatible with the vehicle from the fuel providers within the search area;
if the vehicle is compatible with two or more fuel types then for each fuel price per unit of measure received normalizing the fuel price per unit as a price per unit of distance; and
ranking the fuel providers from lowest to highest fuel price per unit of distance.

10. The method of claim 1, further comprising initiating generation of in-vehicle fuel-related information upon a user command, upon the estimated driving distance remaining for the vehicle falling below a safety margin distance threshold value, or upon the fuel level falling below a fuel level threshold value.

11. An apparatus for providing in-vehicle fuel-related information, comprising:
a processing circuit responsive to executable instructions which, when executed by the processing circuit:
determines a geographic location of a vehicle;
estimates a driving distance remaining for the vehicle based on a current fuel level and a fuel consumption rate of the vehicle;
locates fuel providers within a search area of the driving distance remaining for the vehicle; and
outputs one or more of the fuel providers.

12. The apparatus of claim 11, wherein the processing circuit determines the search area by:
comparing the driving distance remaining for the vehicle with a search distance threshold; and
setting the search area to the lesser of the driving distance remaining for the vehicle and the search distance threshold.

13. The apparatus of claim 11, wherein the processing circuit further receives a user preference for optimum time, and constrains the search area based upon a direction of travel of the vehicle such that fuel providers closer to the direction of travel are preferred over fuel providers in an opposite direction of travel.

14. The apparatus of claim 11, wherein the processing circuit further receives a user preference for optimum time and a vehicle destination, and constrains the search area based upon a route of travel to the vehicle destination such that fuel providers closer to the route of travel are preferred over fuel providers further from the route of travel.

15. The apparatus of claim 11, wherein the processing circuit further receives a fuel price per unit of measure for a fuel type compatible with the vehicle from the fuel providers within the search area and ranks the fuel providers from lowest to highest fuel price per unit of measure.

16. The apparatus of claim 15, wherein the processing circuit further adjusts the ranking of the fuel providers within the search area by favoring previously selected fuel providers.

17. The apparatus of claim 15, wherein the processing circuit further adjusts the ranking of the fuel providers within the search area by favoring fuel providers in closer geographic proximity to the vehicle.

18. The apparatus of claim 15, wherein the outputting includes the fuel providers within the search area and their associated rankings.

19. The apparatus of claim 11, wherein the processing circuit further:
receives a fuel price per unit of measure for one fuel type compatible with the vehicle from the fuel providers within the search area;
if the vehicle is compatible with two or more fuel types then for each fuel price per unit of measure received normalizes the fuel price per unit as a price per unit of distance; and
ranks the fuel providers from lowest to highest fuel price per unit of distance.

20. A method for providing in-vehicle fuel related information, the method comprising:
initiating a travel cost calculation;
determining an initial amount of fuel available in a vehicle prior to an additional amount of fuel being added;
determining the cost of the initial amount of fuel, comprising:
receiving information about the cost-per-unit-of-measure of the initial amount of fuel, and multiplying this cost-per-unit-of-measure by the initial amount;
sensing an additional amount of fuel being added to the vehicle, determining the amount of fuel added, and determining the total amount of fuel available from the initial amount and the amount added;
determining the cost of the additional amount of fuel, comprising:
receiving from a provider of the additional amount of fuel the provider's cost-per-unit-of-measure, and multiplying the provider's cost-per-unit-of-measure by the additional amount;
determining the average monetary value of the total amount of fuel, comprising:
adding the cost of the initial amount of fuel to the cost of the additional amount of fuel to determine a total cost of the total amount of fuel, and dividing the total cost by the total amount of fuel to determine the average-cost-per-unit-of-measure of the total amount of fuel available;
providing to a user of the vehicle the average monetary value of the total amount of fuel available, comprising:
providing to a user of the vehicle the average-cost-per-unit-of-measure of the total amount of fuel available, the total cost of the total amount of fuel available, or both; and
concluding the travel cost calculation, and in response thereto, determining the amount of fuel consumed since the initiating step, and calculating the cost of the fuel consumed by multiplying the amount of fuel consumed by the average monetary value of the total amount of fuel available, the average monetary value being provided as a per-unit-of-measure value.
